(19) United States
(12) Patent Application Publication
(10) Pub. No.: US 2024/0248653 A1
(43) Pub. Date: Jul. 25, 2024

(54) SYSTEM AND METHOD

(71) Applicant: CANON KABUSHIKI KAISHA, Tokyo (JP)

(72) Inventor: SATOSHI TAMURA, Kanagawa (JP)

(21) Appl. No.: 18/419,242

(22) Filed: Jan. 22, 2024

(30) Foreign Application Priority Data
Jan. 23, 2023 (JP) 2023-007774

(51) Int. Cl. G06F 3/12

(52) U.S. Cl. CPC G06F 3/121; G06F 3/1234; G06F 3/1287; G06F 3/1288

(57) ABSTRACT

A system identifies, based on a predetermined error occurring in an image processing apparatus, a plurality of parts each having a possibility of eliminating the predetermined error by being replaced, determines a failure possibility of each of the identified plurality of parts, calculates a failure cause probability of each of the identified plurality of parts based on field results, and provides data for performing a display including parts information including those results.

### BACKGROUND

### Field of the Disclosure

The present disclosure relates to a technique for providing information for eliminating an error that has occurred in an image processing apparatus such as a printer.

### Description of the Related Art

Conventionally, a system that manages the information and status of an image processing apparatus (hereinafter referred to as a device) such as a printer, a copier, or a multifunction peripheral has been constructed. When a failure occurs in the device, a server of the system receives a failure notification transmitted from the device and manages the occurrence situation of the failure (when and which error has occurred in which device). As a similar technique, a mechanism for diagnosing a failure by analyzing the details of the failure has been discussed. There is also a system that displays guidance on replacement of a faulty part based on a result of the failure diagnosis performed in the device and previous replacement results.

Japanese Patent Application Laid-Open No. 2020-199704 discusses a technique of receiving a failure diagnosis result transmitted from a device, calculating work priorities for faulty parts based on the numbers of faulty parts that have actually been replaced with repair parts in the field, and returning information about the work priorities to the device, thereby displaying guidance on replacement of the faulty parts.

Other than using the actual numbers of replacements in the field, it is possible to determine one or more parts having a high possibility of failure (one or more faulty parts) using a technique in which a faulty part relating to an occurring event is identified based on a rule or is estimated using a trained model. However, the priority order of candidate faulty parts determined using the technique and the replacement priority order determined in descending order of the actual numbers of replacements described above may be different from each other depending on the failure.

The actual numbers of replacements in the field are counted from records of parts actually replaced when service engineers have restored the devices from failures in sites where the devices are installed. However, the records of replaced parts may include a record of replacement unrelated to the target failure and a record of replacement performed as a precaution. As for infrequent failures, the percentages of the numbers of replacements may be high. Thus, the above-described difference in priority order occurs.

For this reason, in a conventional system, for example, in a case where the actual number of replacements for a part is large in the field, even if the part is determined to have a low possibility of failure, a service engineer may be informed of the part as a part having a higher priority in remedy such as replacement. In this case, costs may be wasted due to unnecessary adjustment or replacement. In an opposite case, incorrect work may be performed as a result of trial and error in the failure restoration.

### SUMMARY

According to an aspect of the present disclosure, a system that provides information about a part for which a remedy is to be implemented to eliminate an error occurring in an image processing apparatus includes a management unit configured to manage, as field results, accumulated records of remedies that have been implemented for errors in image processing apparatuses in a past, wherein each of the field results includes information about an error, information about a model of an image processing apparatus in which the error has occurred, and information about a remedy for the error, an identification unit configured to identify, based on a predetermined error occurring in an image processing apparatus, a plurality of parts each having a possibility of eliminating the predetermined error by being replaced, a determination unit configured to determine a failure possibility of each of the identified plurality of parts based on the predetermined error and a history of errors that have occurred in the image processing apparatus in which the predetermined error occurs, a calculation unit configured to calculate a failure cause probability of each of the identified plurality of parts based on information, in the field results, that matches the predetermined error and a model of the image processing apparatus in which the predetermined error occurs, and a provision unit configured to provide, as information for eliminating the predetermined error, data for performing a display including information about the plurality of parts. In the display, among the plurality of parts, for a part determined to be high in the failure possibility, information about the failure cause probability is provided, and for a part determined to be low in the failure possibility, information about not the failure cause probability but the failure possibility is provided.

Further features of the present disclosure will become apparent from the following description of embodiments with reference to the attached drawings.

### BRIEF DESCRIPTION OF THE DRAWINGS

FIG. 1 is a diagram illustrating an example of an entire configuration of a system.

FIGS. 2A and 2B are diagrams illustrating an example of hardware configurations of a repair target part notification server, a personal computer (PC), and a printer.

FIG. 3 is a diagram illustrating an example of software module configurations of the repair target part notification server, the PC, and the printer.

FIG. 4 is a flowchart illustrating determination processing by the system including the repair target part notification server.

FIGS. 5A and 5B are flowcharts illustrating details of part of processing by the repair target part notification server.

FIG. 6 is a diagram illustrating an example of a repair procedure display screen provided by the repair target part notification server.

FIG. 7 is a diagram illustrating an example of software module configurations according to a second embodiment.

FIG. 8 is a diagram illustrating an example of a repair procedure display screen provided by a repair target part notification server according to the second embodiment.

### DESCRIPTION OF THE EMBODIMENTS

Exemplary embodiments of the present disclosure will be described below with reference to the drawings.

### <System Configuration>

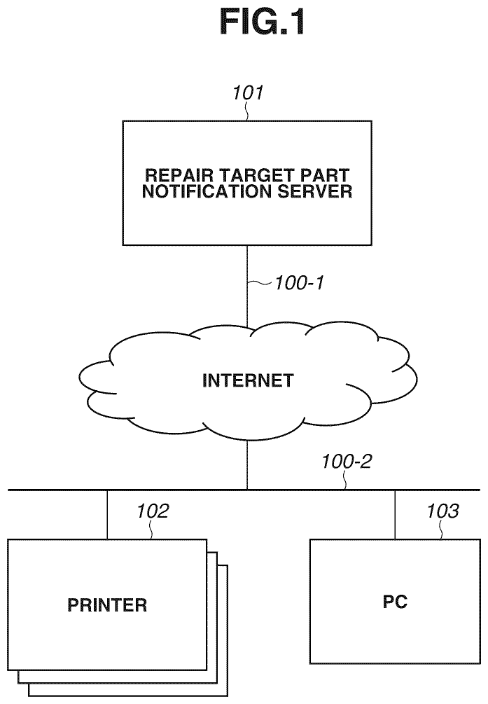

FIG. 1 is a block diagram illustrating a configuration example of a device management system according to a first embodiment of the present disclosure.

The device management system includes a repair target part notification server 101, a printer 102, and a personal computer (PC) 103 that are communicable with each other via a network 100 (including subnetworks 100-1 and 100-2). The repair target part notification server 101 is arranged on the Internet.

The network 100 is a communication network implemented by, for example, the Internet, a local area network (LAN), a wide area network (WAN), or a telephone line, and enables transmission and reception of data. In FIG. 1, the network 100 is divided into the subnetworks 100-1 and 100-2, but there is no difference in function between the subnetworks 100-1 and 100-2.

The repair target part notification server 101 receives, from the printer 102, error information indicating an error occurring in the printer 102 and estimates information about one or more parts to be repaired to eliminate the error. The repair target part notification server 101 accumulates and manages, as field results, records of remedies, such as parts replacement, that have been implemented for similar errors in the field in the past. The repair target part notification server 101 determines priorities of the parts to be repaired, based on the field results.

The repair target part notification server 101 uses a cloud computing technique on the Internet. Processing performed by the repair target part notification server 101 according to the present embodiment may be implemented by a plurality of servers (functions) implemented by a plurality of virtual machines. As an example of the implementation method, a server that performs a reception service and a server that performs processing based on error information received by the reception service can be separately implemented in the management system. The system may have an on-premise configuration using a physical server.

The printer 102 is an example of image processing apparatuses, such as a printer and a multifunction peripheral (MFP), and has a print function, a facsimile function, a copy function, and a scan function. When the printer 102 detects an occurrence of an error therein, the printer 102 transmits error information including device information to the repair target part notification server 101. A plurality of the printers 102 may be included in the system.

The PC 103 is an example of an information processing apparatus, and a predetermined operating system (OS) (not illustrated) is installed on the PC 103. A browser 331 (described below) is also installed on the PC 103. The PC 103 transmits a request to acquire information about the parts to be repaired in the printer 102 to the repair target part notification server 101 via the browser 331, receives the information about the parts to be repaired from the repair target part notification server 101, and displays the information about the parts to be repaired, by using a graphical user interface (GUI).

### <Hardware Configuration>

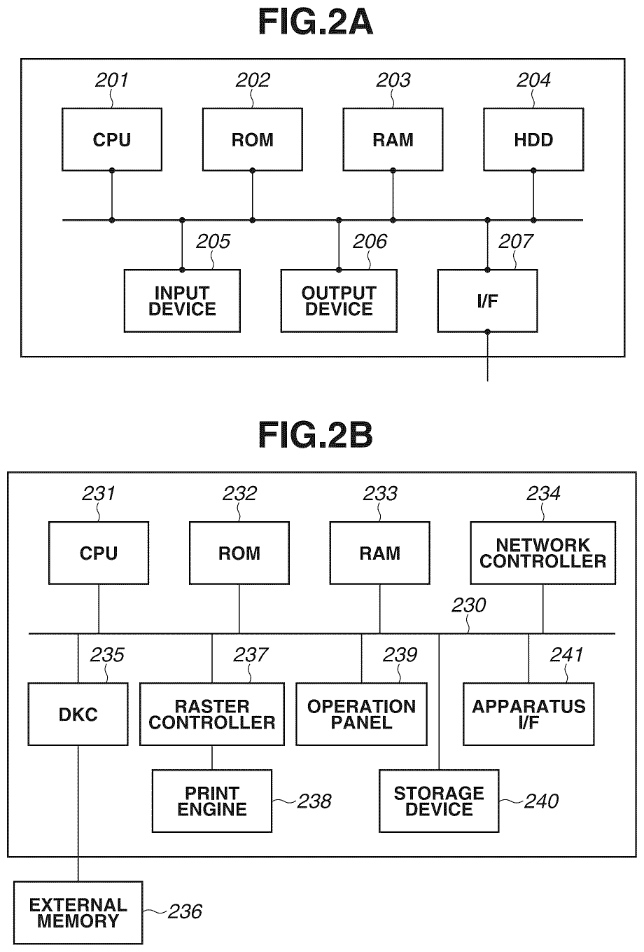

FIG. 2A is a block diagram illustrating a hardware configuration of each of the repair target part notification server 101 and the PC 103 in FIG. 1. In FIG. 2A, a central processing unit (CPU) 201 directly or indirectly controls devices (described below), such as a read only memory (ROM) 202 and a random-access memory (RAM) 203, connected via an internal bus, and executes programs for implementing the present embodiment. The ROM 202 stores a basic input/output system (BIOS). The RAM (primary storage device) 203 is used as a work area for the CPU 201 and is used as a temporary storage area where software modules for implementing the present embodiment are loaded. A hard disk drive (HDD) 204 is a secondary storage device and stores the OS serving as basic software and the software modules. A solid state drive (SSD) may be used instead. An input device 205 includes a keyboard and a pointing device (which are not illustrated). An output device 206 is connected to a display. An interface (I/F) 207 is used to connect to the network 100.

In the foregoing hardware, after startup, the CPU 201 executes the BIOS, and the OS is loaded from the HDD 204 into the RAM 203 to be executable. The CPU 201 loads various software modules (described below) from the HDD 204 into the RAM 203 to be executable as appropriate, based on operation of the OS. The various software modules are executed and operated by the CPU 201 in cooperation with the above-described devices. The I/F 207 is connected to the network 100, such as the Internet or a local network, and is controlled by the CPU 201 based on the operation of the OS, thereby implementing communication using the above-described communication method.

FIG. 2B is a block diagram illustrating a hardware configuration of the printer 102. In the hardware configuration, components except for a print engine 238 are also referred to as a controller that manages a control system of the printer 102. The hardware components are connected to a system bus 230.

A CPU 231 controls the entire operation of the printer 102 and comprehensively controls access to various devices connected to the system bus 230. The control is based on control programs stored in a ROM 232, or control programs and resource data (resource information) stored in an external memory 236 connected via a disk controller (DKC) 235. A RAM 233 functions as a main memory or a work area for the CPU 231 and is configured such that a memory capacity can be expanded by an optional RAM connected to an expansion port (not illustrated). A storage device 240 is an external storage device functioning as a large-capacity memory. An operation panel (an operation unit) 239 displays a screen and receives an operation instruction from a user via the screen. The operation panel 239 also includes buttons and a display unit, such as a liquid crystal panel, which are used to perform operations such as setting the operation mode of the printer 102, displaying the operation state of the printer 102, and selecting the content data to be printed. A network controller 234 is, for example, a network interface card (NIC), and data is exchanged with an external apparatus via the network controller 234. A raster controller 237 converts, for example, print data described in a page-description language (PDL) into image data. The print engine 238 uses a known print technique to form an image on a sheet based on the image data input from the raster controller 237. Examples of the print engine 238 include a print engine of an electrophotographic system (a laser beam system), a print engine of an inkjet system, and a print engine of a sublimation (thermal transfer) system. An apparatus I/F 241 is a connection I/F with an external apparatus connectable via a universal serial bus (USB) or the like.

### <Software Configuration>

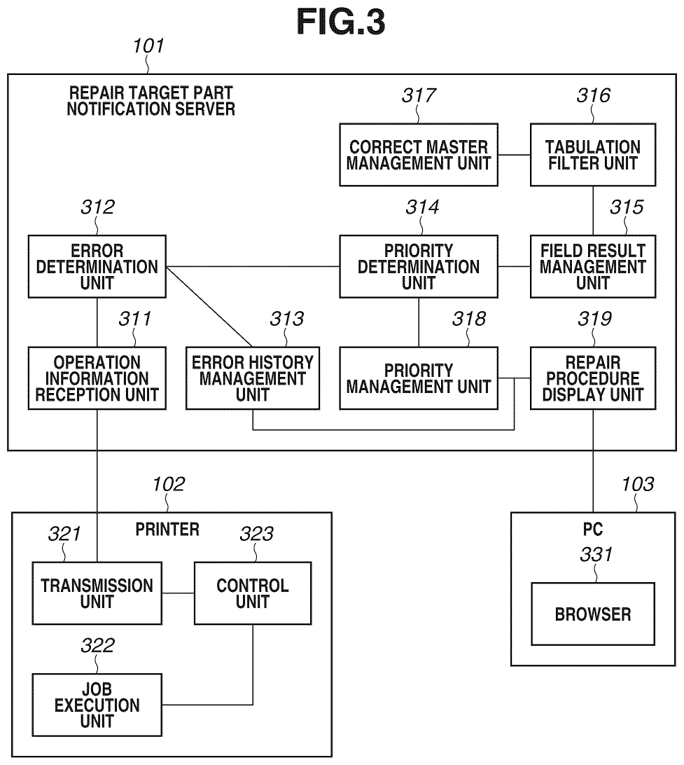

Operations of the apparatuses (the repair target part notification server 101, the printer 102, and the PC 103) included in the system according to the present embodiment, which are mainly performed by the software modules of the apparatuses, will be described with reference to FIG. 3. The operations are implemented by the respective CPUs of the apparatuses executing programs according to the present embodiment stored in the respective memories. Schemas and data in tables (described below) are merely examples, and the schemas of the tables and the formats of various kinds of data are not limited thereto.

The repair target part notification server 101 includes an operation information reception unit 311, an error determination unit 312, an error history management unit 313, a priority determination unit 314, a field result management unit 315, a tabulation filter unit 316, a correct master management unit 317, a priority management unit 318, and a repair procedure display unit 319.

The operation information reception unit 311 receives operation information from the printer 102. The operation information includes error information indicating an abnormality or a failure occurring in the printer 102, various kinds of log information, and sensor information detected by various sensors in the printer 102. The operation information further includes counter information indicating the number of sheets subjected to printing by the printer 102, and parts counter information indicating the consumption level of each part. The operation information is transmitted from the printer 102 at different schedules depending on the content, or the operation information that puts a plurality of contents together is transmitted under a specific condition.

Upon receiving the error information from the operation information reception unit 311, the error determination unit 312 acquires an error history from the error history management unit 313. The error history acquired at this time is information about errors that have occurred in the past in the printer 102 in which an error indicated by the error information occurs. The error determination unit 312 further determines, based on the received error information, one or more parts to be repaired in order to eliminate the error, and whether a failure possibility of each of the parts is “high” or “low”. The determination result is transmitted to the priority determination unit 314 (described below) together with the error information. The error determination unit 312 also stores, as an error record, the error information received from the printer 102 into the error history management unit 313. Table 1 illustrates an example of the determination result about certain error information, which is output from the error determination unit 312.

TABLE 1

| Part Number | Failure Possibility |
|---|---|
| Part1-111 | High |
| Part2-222 | High |
| Part3-333 | High |
| Part4-444 | Low |
| Part5-555 | Low |

As indicated in Table 1, the determination result includes information about one or more parts to be repaired, which are a possible cause of the error. More specifically, the determination result includes a part number uniquely identifying each of the parts and a failure possibility of each of the parts.

The error determination unit 312 determines, as the determination result, (part numbers of) target parts that have possibilities of eliminating the error, based on a predetermined rule by using the error information and the error history.

At this time, the determination is performed based on the rule. Thus, in the case of an error for which no rule is managed, the error determination unit 312 may output an empty part number list indicating that target parts information cannot be identified, as the determination result of parts information.

In the present embodiment, the determination by the error determination unit 312 is not limited to the determination of the parts information based on the rule. For example, the error determination unit 312 may estimate information about one or more parts to be repaired, through estimation processing using a trained model generated by supervised machine learning including deep learning, and may use a result of the estimation as the determination result.

The error history management unit 313 stores and manages the error information received from the printer 102, as the error history. Table 2 illustrates an example of part of the error history managed by the error history management unit 313.

TABLE 2

| Error | | Model | Error | Counter | Occurrence |
|---|---|---|---|---|---|
| ID | Device ID | Number | Code | Value | Date and Time |
| Err- | DEV0000001 | Model- | E001- | 5000 | 2022-October- |
| 001 | | 001 | 0001 | | 01T12:34:56Z |
| Err- | DEV0000002 | Model- | E002- | 1500 | 2022-September- |
| 002 | | 002 | 0002 | | 03T00:00:00Z |
| Err- | DEV0000001 | Model- | E003- | 2000 | 2022-September- |
| 003 | | 001 | 0001 | | 01T00:12:34Z |

The error history includes an error identifier (ID) uniquely identifying an error, a device ID uniquely identifying a printer in which the error has occurred, a model number indicating a model of the printer, an error code indicating a type of the error, a counter value that is the number of sheets subjected to printing at a time when the error has occurred, and an occurrence date and time of the error.

Upon receiving the determination result from the error determination unit 312, the priority determination unit 314 acquires, from the field result management unit 315, field results having the same model number and the same error code as those in the error information, and ranks the field results. The priority determination unit 314 stores the ranked field results as estimation results into the priority management unit 318.

The field result management unit 315 accumulates and manages, in a storage system, records of all remedies implemented by service engineers to eliminate error codes of errors that have occurred in image processing apparatuses sold and used by customers in the past. One of tabulations performed by the field result management unit 315 is a tabulation of the numbers of replaced parts. The field result management unit 315 tabulates the numbers of replaced parts for each model number, each error code, and each part number. The other tabulation is a tabulation of remedies, and the field result management unit 315 tabulates the remedies implemented for each model number and each error code. Table 3 illustrates an example of part of field replacement results managed by the field result management unit 315. The field replacement results are obtained by tabulating the actual numbers of replaced parts in the field. The tabulation of remedies will be described below with reference to Tables 5 and 6.

TABLE 3

| Model | Error | Part | Number of |
|---|---|---|---|
| Number | Code | Number | Replacements |
| Model-001 | E001-0001 | Part1-111 | 510 |
| Model-001 | E001-0001 | Part2-222 | 218 |
| Model-001 | E001-0001 | Part3-333 | 92 |
| Model-001 | E001-0001 | Part4-444 | 20 |
| Model-001 | E001-0001 | Part5-555 | 140 |
| Model-001 | E001-0001 | Part6-666 | 20 |
| Model-001 | E002-0002 | Part5-555 | 2000 |

The field results about the numbers of replaced parts include a model number indicating a target model, an error code indicating a type of an error occurring in the model, part numbers of parts replaced to eliminate the error, and the numbers of replacements that are the actual numbers of replaced parts. The priority determination unit 314 determines priorities of the parts to be repaired, based on the tabulation result of the numbers of replaced parts and the determination result by the error determination unit 312.

Table 4 illustrates an example of information about the priorities of the parts determined by the priority determination unit 314.

TABLE 4

| Device ID | Error Code | Part Number | Priority |
|---|---|---|---|
| DEV0000001 | E001-0001 | Part1-111 | 51.0 |
| DEV0000001 | E001-0001 | Part2-222 | 21.8 |
| DEV0000001 | E001-0001 | Part3-333 | 9.2 |
| DEV0000001 | E001-0001 | Part4-444 | — |
| DEV0000001 | E001-0001 | Part5-555 | — |

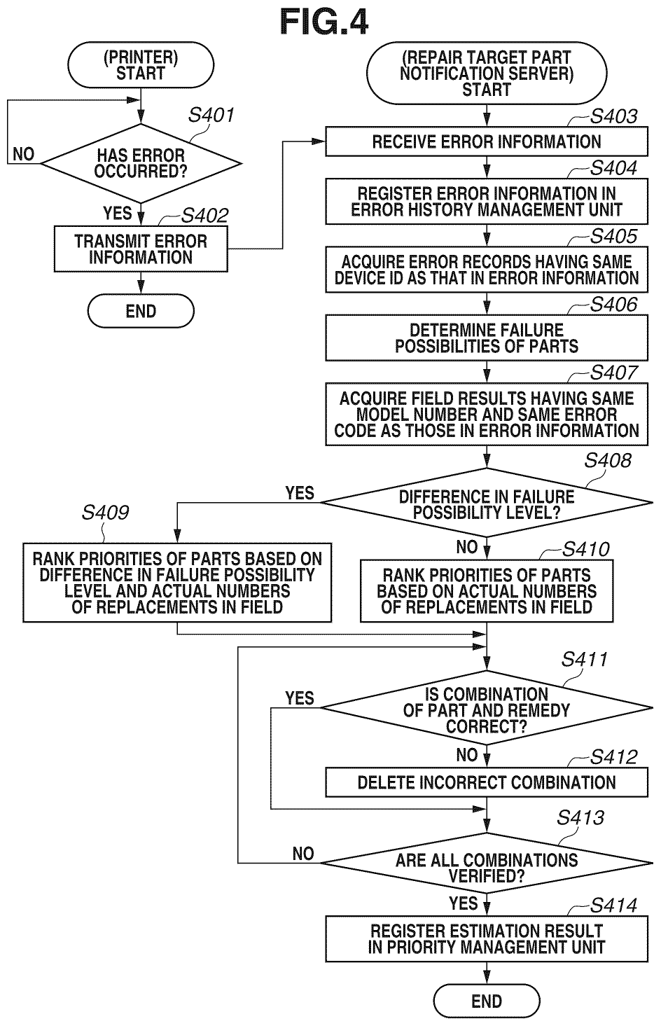

The priority information includes the device ID, the error code, the part numbers of the parts to be repaired for the error, and the priorities of the parts. The priorities each indicate a probability of being the cause of the failure (hereinafter referred to as a failure cause probability), and enable determining the priority order of the parts to be repaired. An example of a method for calculating the priorities will be described in priority determination processing to be described below with reference to FIG. 4.

Table 5 illustrates an example of part of the field remedy results managed by the field result management unit 315. The field remedy results are obtained by tabulating the field results about remedies.

TABLE 5

| Model Number | Error Code | Remedy | Replaced Part |
|---|---|---|---|
| Model-001 | E001-001 | Replacement | Part1-111 |
| Model-001 | E001-001 | Adjustment | |
| Model-001 | E001-001 | Cleaning | |
| Model-001 | E001-001 | Replacement | Part2-222 |
| Model-001 | E001-001 | Adjustment | |
| Model-001 | E002-002 | Cleaning | |
| Model-001 | E002-002 | Cleaning | |
| Model-001 | E002-002 | Adjustment | |
| Model-001 | E003-003 | Replacement | Part3-333 |
| Model-002 | E001-001 | Replacement | Part1-111 |
| Model-002 | E003-003 | Cleaning | |

The field remedy results include a model number indicating a target model, an error code indicating a type of an error that has occurred in the model, a remedy implemented for the error, and a part number of a part replaced in a case where the remedy is replacement.

Table 6 is an example of a table that manages the priorities of remedies determined by the priority determination unit 314.

TABLE 6

| Model Number | Error Code | Remedy | Priority |
|---|---|---|---|
| Model-001 | E001-001 | Replacement | A |
| Model-001 | E001-001 | Adjustment | A |
| Model-001 | E001-001 | Cleaning | B |

Table 6 lists a model number, an error code, remedies, and priorities of the remedies.

The correct master management unit 317 holds a correct master that defines combinations of parts and remedies that are technically and theoretically correct according to the apparatus specifications. The tabulation filter unit 316 has a function of excluding a combination not conforming to the definition of the correct master, among the combinations of parts to be repaired and remedies, which are obtained from Tables 5 and 6, based on the definition by the correct master management unit 317.

The priority management unit 318 manages the priorities of the parts to be repaired, which are determined by the priority determination unit 314, and the remedies in combination with each other. Table 7 illustrates an example thereof.

TABLE 7

| | | | | Failure | | | |
|---|---|---|---|---|---|---|---|
| | | Error | Part | Cause | | | |
| Priority | Device ID | Code | No. | Probability | Replacement | Cleaning | Adjustment |
| 1 | DEV0000001 | E001-001 | Part1-111 | 51 | A | — | A |
| 2 | DEV0000001 | E001-001 | Part2-222 | 21.8 | A | B | — |
| 3 | DEV0000001 | E001-001 | Part3-333 | 9.2 | — | B | A |
| 4 | DEV0000001 | E001-001 | Part5-555 | Low | — | — | — |
| | | | | Possibility | | | |
| 5 | DEV0000001 | E001-001 | Part4-444 | Low | — | — | — |
| | | | | Possibility | | | |

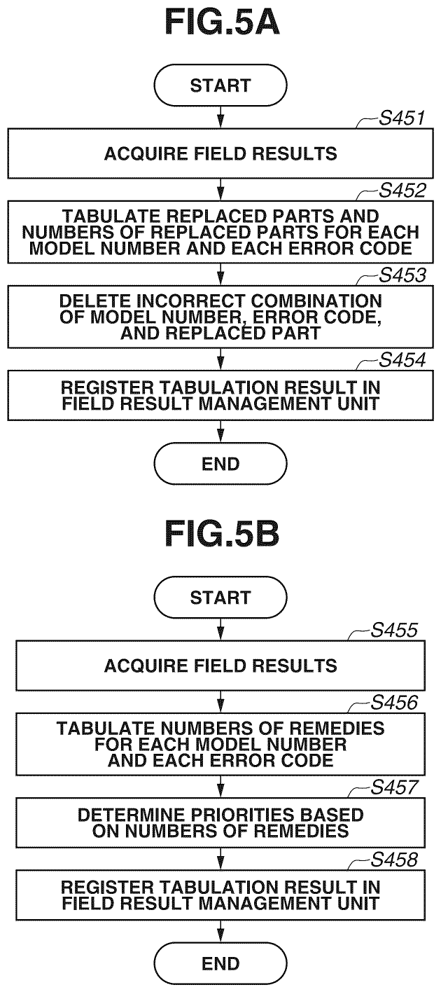

Table 7 lists the priorities of the parts, the device ID, the error code, the part numbers, the failure cause probabilities, and the priorities of the remedies including replacement, cleaning, and adjustment. Calculation methods relating to Tables 6 and 7 will be described in detail in processing to be described below with reference to FIG. 5B.

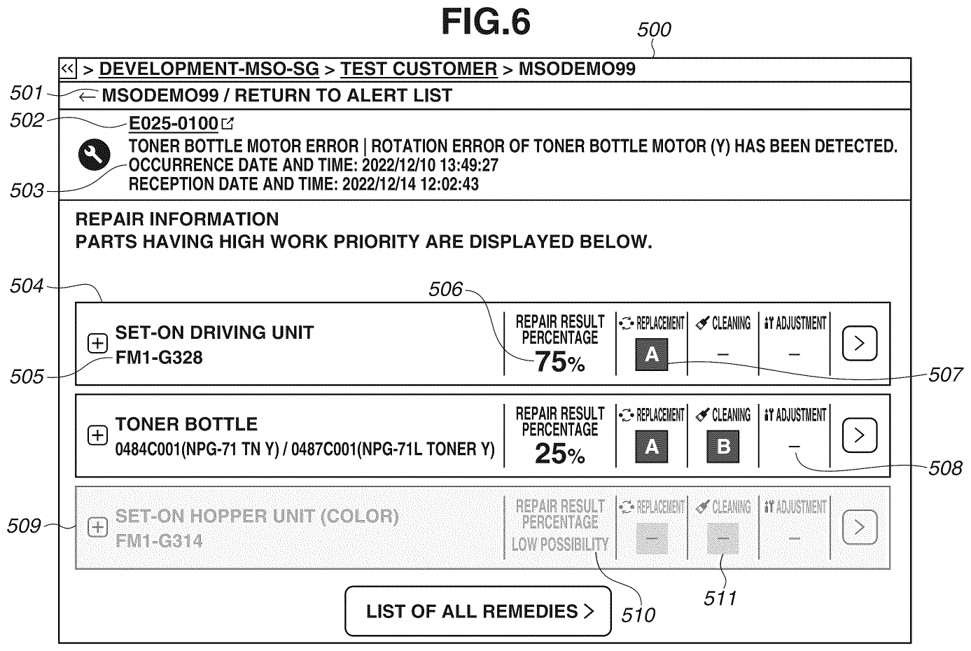

Upon receiving a repair procedure acquisition request, including the device ID and the error ID, from the browser 331 of the PC 103, the repair procedure display unit 319 acquires error records having the same device ID and the same error ID from the error history management unit 313. The repair procedure display unit 319 also acquires the estimation results having the same device ID and the corresponding error code from the priority management unit 318, generates a repair procedure display screen 500 (see FIG. 6), and returns the repair procedure display screen 500 to the browser 331.

The printer 102 includes a transmission unit 321, a job execution unit 322, and a control unit 323.

The transmission unit 321 transmits information about an error occurring in the printer 102, which is collected by the control unit 323 (described below), to the repair target part notification server 101. The job execution unit 322 executes a job submitted to the printer 102. For example, in a case where a print job is submitted to the printer 102, the job execution unit 322 performs print processing based on the print job. The control unit 323 detects an error occurring in the printer 102, collects information about the error, and transmits the error information to the repair target part notification server 101 via the transmission unit 321.

FIG. 4 is a flowchart illustrating processing performed by the printer 102 and the repair target part notification server 101.

In step S401, the control unit 323 of the printer 102 detects whether an error has occurred in the printer 102. If the control unit 323 detects an occurrence of an error (YES in step S401), the processing proceeds to step S402. In step S402, the transmission unit 321 of the printer 102 transmits information about the error to the repair target part notification server 101. Triggered by the transmission of the error information, processing of a service (a repair target notification service) provided by the device management system including the repair target part notification server 101 is started.

In step S403, the operation information reception unit 311 of the repair target part notification server 101 receives the error information. The error information transmitted at this time includes the error ID, the device ID, the model number, the error code, the counter value, and the error occurrence date and time as in the error history in Table 2.

In the present embodiment, an example in which the counter value is included in the error information is described, but, for example, the counter value may be received, from the printer 102, as counter information different from the error information, and the counter value may be associated with the error information.

In step S404, the error determination unit 312 registers the received error information as an error record into the error history management unit 313.

In step S405, the error determination unit 312 acquires error records having the same device ID as that in the error information received in step S403, from the error history managed by the error history management unit 313. For example, in a case where the device ID in the error information is “DEV0000001”, the records in the first row and the third row in Table 2 are acquired.

In step S406, the error determination unit 312 outputs a list of part numbers and failure possibilities of the parts to be repaired to eliminate the error, based on the rule by using the error information received from the printer 102 and the error records acquired from the error history management unit 313. In the present embodiment, the error determination unit 312 identifies the parts to be repaired, using a rule-based method with the received error information and the history of errors that have occurred in the same device in the past, and outputs the determination result. Alternatively, as described above, the error determination unit 312 may perform estimation processing using the error information received in step S403 as an input by using a trained model generated by supervised machine learning including deep learning, and may output the determination result.

In step S407, the priority determination unit 314 acquires the field replacement results and the field remedy results each having the same model number and the same error code as those in the error information, from the field result management unit 315. For example, in a case where the model number and the error code in the error information are “Model-001” and “E001-0001”, respectively, the records from the first row to the sixth row in Table 3 are acquired as the field replacement results, and the records in all the rows in Table 6 are acquired as the field remedy results. Methods for calculating the field replacement results and the field remedy results will be described below.

In step S408, the priority determination unit 314 checks the determination result of the parts to be repaired, which is output from the error determination unit 312. More specifically, in a case where the failure possibilities of all the parts, which are the information indicating possibilities about the remedies of the parts, are not “low” in the list of part numbers and failure possibilities output in step S406, the priority determination unit 314 determines that there is a predetermined difference in failure possibility level among the parts having the output part numbers. In a case where the priority determination unit 314 determines that there is a predetermined difference in failure possibility level among the parts (YES in step S408), the processing proceeds to step S409. In a case where the failure possibilities of all the parts are “low”, the priority determination unit 314 determines that there is no predetermined difference in failure possibility level among the parts (NO in step S408), and the processing proceeds to step S410.

In step S409, the priority determination unit 314 acquires the numbers of replacements for the same part numbers as those in the list of failure possibilities output in step S406. The priority determination unit 314 then calculates the failure cause probabilities using “(the number of replacements for each part/the total number of all the parts replaced to eliminate an error)×100”, and associates the failure cause probabilities with the corresponding part numbers. In other words, the priority determination unit 314 calculates the failure cause probabilities of the parts so that the sum of the failure cause probabilities of all the parts replaced to eliminate an error code occurring in a certain model becomes 100%.

In the present embodiment, the failure cause probabilities are each calculated as the percentage of the number of replacements for each part to be repaired to the total number of replacements for all the parts to be repaired, but the method for calculating the failure cause probabilities is not limited to the method according to the present embodiment, and any other method can be used.

For example, in a case where the field replacement results acquired in step S407 are the records in the first row to the sixth row in Table 3 described above, the total number of all the replaced parts is 1000, which is the sum of the numbers of replacements in the field replacement results.

In this case, the failure cause probability of the part number “Part1-111” is “(510/1000)×100=51.0”. Likewise, the failure cause probabilities of the part numbers “Part2-222”, “Part3-333”, “Part4-444”, and “Part5-555” are “21.8”, “9.2”, “2.0”, and “14.0”, respectively.

The priorities are ranked at this time. In the processing in step S409, the priorities are ranked in consideration of not only the failure cause probabilities, but also the result of whether each of the parts has a “low” possibility of failure in the list of failure possibilities output from the error determination unit 312 in step S406.

For example, the failure cause probability of the part number “Part1-111” is “(510/1000)×100=51.0”. Likewise, the failure cause probabilities of the part numbers “Part2-222”, “Part3-333”, “Part4-444”, and “Part5-555” are “21.8”, “9.2”, “2.0”, and “14.0”, respectively.

In a case where the failure possibilities of the part numbers “Part1-111”, “Part2-222”, “Part3-333”, “Part4-444”, and “Part5-555” are “high”, “high”, “high”, “low”, and “low”, respectively, the parts with a “high” possibility of failure and the parts with a “low” possibility of failure are separately sorted in descending order of the failure cause probabilities. In this case, the priorities “1” to “5” are assigned to “Part1-111”, “Part2-222”, “Part3-333”, “Part5-555”, and “part4-444”, respectively.

Further, the failure cause probabilities of the part numbers “Part4-444” and “Part5-555” with a “low” possibility of failure are changed from the values expressed in percent (%) to a character string “low possibility”.

In step S411, the tabulation filter unit 316 verifies each of combinations of the parts to be repaired, which are determined in the above-described processing, and remedies, and determines whether the combination conforms to the combinations of parts and remedies that are technically and theoretically correct according to the apparatus specifications, based on the correct master. Depending on the part, any of the remedies of “replacement”, “cleaning”, and “adjustment” may be unavailable or meaningless. In a case where the tabulation filter unit 316 determines that the combination does not conform to the correct combinations of parts and remedies defined by the correct master (NO in step S411), the processing proceeds to step S412. In step S412, the tabulation filter unit 316 deletes data on the nonconforming combination.

In step S413, the tabulation filter unit 316 determines whether all the combinations of the parts and the remedies have been verified. In a case where all the combinations have not been verified (NO in step S413), the processing returns to step S411, and the tabulation filter unit 316 makes the determination about the next combination in step S411.

In a case where all the combinations have been verified (YES in step S413), the processing proceeds to step S414.

In step S414, the priority determination unit 314 registers, as the estimation results, the calculated priorities of the remedies together with the device ID and the error code in the error information, into the priority management unit 318. For example, Table 7 illustrates an example of the estimation results of recommended remedies calculated from the examples of Tables 4 and 6.

In the above-described manner, recommended remedies for an error occurring in the printer 102 can be estimated.

Processing to be described below with reference to FIGS. 5A and 5B is processing performed by the repair target part notification server 101 asynchronously with the processing in FIG. 4.

FIG. 5A is a flowchart illustrating field replacement result tabulation processing by the repair target part notification server 101.

In step S451, the field result management unit 315 acquires the field results that have already been accumulated and managed. The field results acquired at this time include at least model numbers, error codes, and replaced parts information.

In step S452, the field result management unit 315 tabulates the replaced parts and the numbers of replaced parts for each model number and each error code. Table 3 described above illustrates an example of part of the tabulation result. Through the processing, it is possible to obtain the tabulation result of the field replacement results.

In step S453, by using the correct master managed by the correct master management unit 317, an incorrect combination included in the tabulation result is deleted among the combinations of the model numbers, the error codes, and the replaced parts included in the field results.

In step S454, the field result management unit 315 newly manages the tabulation result of the field replacement results calculated up to step S453. At this time, the field result management unit 315 may manage the tabulation result by updating the tabulation result managed before then. The field result management unit 315 holds the tabulation result of the field replacement results in the above-described manner. The tabulation result is used in step S407 in FIG. 4.

FIG. 5B is a flowchart illustrating field remedy result tabulation processing by the repair target part notification server 101.

In step S455, the field result management unit 315 acquires the field results that have already been accumulated and managed. The field results acquired at this time include at least model numbers, error codes, and information about implemented remedies. Table 5 described above illustrates an example of the information acquired at this time. In step S456, the field result management unit 315 tabulates the numbers of implemented remedies for each model number and each error code.

In step S457, the field result management unit 315 causes the priority determination unit 314 to determine the priorities of the remedies based on the numbers of the remedies included in the result acquired in step S456. At this time, the remedies acquirable as the field results are classified into three types of “replacement”, “adjustment”, and “cleaning”, and tabulated. The numbers of remedies in the result are tabulated for each model number and each error code, and the percentages of the remedies are determined. The priority of the remedy having the largest percentage is set to “A”. Based on the remedy having the largest percentage, in a case where a difference in percentage between the remedy and another remedy is 5% or less, the priority of the other remedy is set to “A”. In a case where a difference in percentage between the remedy and another remedy is greater than 5% and 20% or less, the priority of the other remedy is set to “B”. In a case where a difference in percentage between the remedy and another remedy is greater than 20%, the priority of the other remedy is set to “C”. For example, in a case where the percentage of “replacement” is 50%, the percentage of “cleaning” is 35%, and the percentage of “adjustment” is 15%, the priority of “replacement” is set to “A”, the priority of “cleaning” is set to “B”, and the priority of “adjustment” is set to “C”. The estimation results of recommended remedies based on the example of Table 5 are stored and managed as in Table 6 described above.

In step S458, the field result management unit 315 registers the tabulation result of the field remedy results in steps S455 to S457. The field result management unit 315 holds the tabulation result of the field remedy results in the above-described manner.

<Example of Display Screen Including Information about Parts to be Repaired>

FIG. 6 illustrates an example of the repair procedure display screen 500 displayed on the browser 331. The repair target part notification server 101 receives the repair procedure acquisition request, including the device ID and the error code, from the browser 331 of the PC 103. In this case, the repair procedure display unit 319 of the repair target part notification server 101 provides, to the browser 331, data, such as hypertext markup language (HTML) data, on the repair procedure display screen 500 illustrated in FIG. 6.

The repair target part notification server 101 according to the present embodiment is a system that displays, for each error, a repair procedure for eliminating the error. The repair procedure display screen 500 includes a repair procedure for eliminating an error specified from the browser 331.

The repair procedure display screen 500 displays the error history managed by the repair target part notification server 101 and the estimation results. A device ID area 501 displays a device ID in an error record having the same error code as that specified by the repair procedure acquisition request, in the error history managed by the error history management unit 313.

An error code area 502 displays an error code in an error record having the same error code as that specified by the repair procedure acquisition request, in the error history managed by the error history management unit 313. An occurrence date and time area 503 displays an occurrence date and time in an error record having the same error code as that specified by the repair procedure acquisition request, in the error history managed by the error history management unit 313.

A part information area 504 displays an estimation result having the same error code as that specified by the repair procedure acquisition request, among the estimation results managed by the priority management unit 318. A part number area 505 displays the corresponding part number managed by the priority management unit 318.

The repair procedure display unit 319 displays the parts information in descending order of the priorities based on the failure cause probabilities. This makes it possible to present, to the user, which part is to be repaired more preferentially. In the present embodiment, the estimation results are simply displayed in the order of the priorities. Alternatively, in a case where a plurality of estimation results includes an estimation result having the priority exceeding a certain threshold, for example, an icon or a message indicating “the part to be repaired” may be additionally displayed for the estimation result, on the repair procedure display screen 500.

A repair result percentage area 506 displays the failure cause probability of a target part that is calculated by the priority determination unit 314 in step S409 and is managed by the priority management unit 318. As described above, the failure cause probability indicates the percentage of the number of replacements for the target part to the total number of all the parts replaced when the same error has occurred in the same model.

A recommended remedy area 507 displays the priorities of “replacement”, “cleaning”, and “adjustment” by using “A”, “B”, and “C” based on the estimation results of the recommended remedies managed by the priority management unit 318. Depending on the part, a specific remedy is unavailable as in the case of the combination deleted in the above-described processing in steps S411 and S412. In this case, a symbol “-” is displayed like a recommended remedy area 508 based on the management by the priority management unit 318.

In the case of a part that is determined to be low in failure possibility by the error determination unit 312, the part information is displayed on a lower part of the screen based on the priorities managed by the priority management unit 318, in a grayed-out manner. A part information area 509 displays an example of a part whose failure cause probability is determined as “low possibility” in the processing in FIGS. 4 and 5A. A repair result percentage area 510 for this part displays not a numerical value but the character string “low possibility”. In this case, the part information is displayed on the lower part based on the priorities managed by the priority management unit 318, in a grayed-out manner. Further, a recommended remedy area 511 displays a symbol “-” for the priority of the remedy. Displaying the symbol “-” using a different background color makes it possible to distinguish the symbol “-” from the symbol “-” filtered by the correct master.

In the above-described manner, the repair target part notification server 101 can rank the parts and the remedies for eliminating an error occurring in an image processing apparatus, in descending order of possibility of eliminating the error, and can also provide information about a recommended remedy for the error.

In the above-described description with reference to FIG. 4, the case where the error determination unit 312 outputs a list including one or more parts having a high possibility of failure in step S406 is assumed and described. However, the error determination unit 312 may output a list of only parts having a low possibility of failure without outputting a list including a part having a high possibility of failure. In this case, when the processing described above is performed, information about all the parts is displayed in a grayed-out manner on a screen such as that illustrated in FIG. 6, the failure cause possibilities of all the parts are displayed as “low possibility”, and the priorities “A”, “B”, and “C” of the remedies are not displayed. Thus, insufficient information may be provided to the user.

In the following, processing for providing appropriate parts information even in a case where the error determination unit 312 outputs a list of only parts having a low possibility of failure will be described in detail. More specifically, in a case where all the parts have a “low” possibility of failure in the above-described determination in step S408 in FIG. 4, the processing in step S410 is performed.

In step S410, in the above-described case based on Table 3, the processing of changing the expression of the failure cause probability based on whether the failure possibility of each part is determined as “high” or “low”, which is performed by the error determination unit 312 in step S409, is not performed. Table 8 illustrates information used in step S410.

TABLE 8

| | | | | Failure | | | |
|---|---|---|---|---|---|---|---|
| | | Error | Part | Cause | | | |
| Priority | Device ID | Code | No. | Probability | Replacement | Cleaning | Adjustment |
| 1 | DEV0000001 | E001-001 | Part1-111 | 51 | A | — | A |
| 2 | DEV0000001 | E001-001 | Part2-222 | 21.8 | A | B | — |
| 3 | DEV0000001 | E001-001 | Part5-555 | 14 | A | B | — |
| 4 | DEV0000001 | E001-001 | Part3-333 | 9.2 | A | B | A |
| 5 | DEV0000001 | E001-001 | Part4-444 | 2 | A | — | — |

Table 8 lists the priorities of the parts, the device ID, the error code, the part numbers, the failure cause probabilities, and the priorities of the remedies such as replacement, cleaning, and adjustment. The information in Table 8 is calculated using a method similar to the method used in Table 7 described above, except for editing of the information about the failure cause probabilities by the error determination unit 312. In step S410, information such as that indicated in the example of Table 8 is stored as the result. After the processing in step S410, the processing in steps S411 to S414 is performed as described above.

Thereafter, the repair target part notification server 101 receives the repair procedure acquisition request, including the device ID and the error code, from the browser 331 of the PC 103. In this case, the repair procedure display unit 319 of the repair target part notification server 101 provides, to the browser 331, data, such as HTML data, for providing parts information based on the information in Table 8. On a screen displayed on the browser 331 based on the information in Table 8, the part information area 509, the repair result percentage area 510, and the recommended remedy area 511 are not displayed. All the parts to be repaired are displayed without being grayed out, and the numerical values of the failure cause probabilities and the priorities of the remedies included in Table 8 are displayed without being changed.

In the first embodiment, even in a case where all the parts are determined to be low in failure possibility by the error determination unit 312, display is performed based on the processing in step S410. In the first embodiment, the case where all the parts are determined to be “high” in failure possibility and the case where all the parts are determined to be “low” in failure possibility result in the same display. However, in a case where all the parts are determined to be “low” in failure possibility, it is desirable that the information be provided while being distinguished from other information to improve quality of information provision.

In a second embodiment, the repair target part notification server 101 includes a reliability determination unit 320 in addition to the configuration illustrated in FIG. 3 according to the first embodiment, and additionally provides a display enabling identification of accuracy (reliability) of provided information.

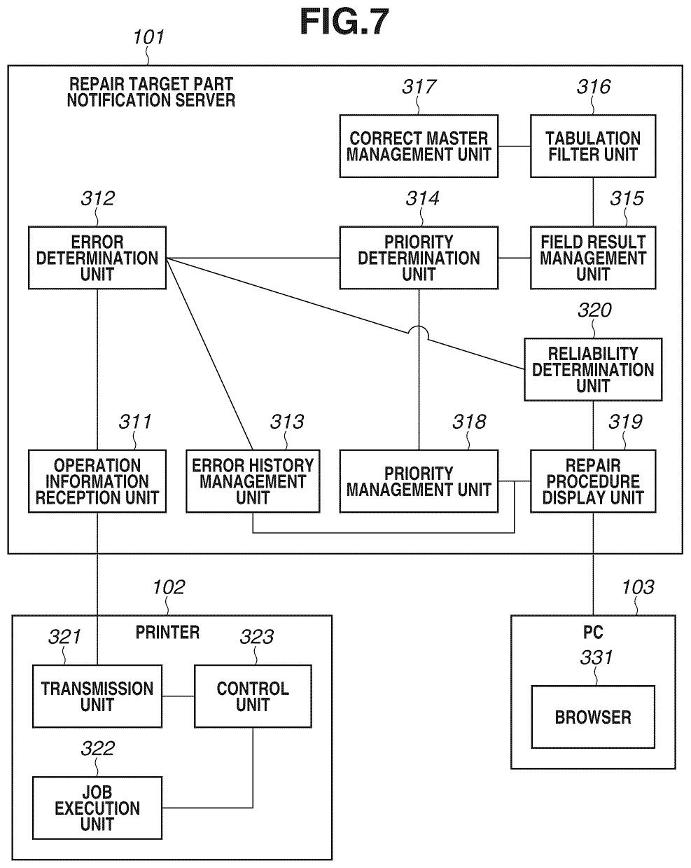

FIG. 7 illustrates a software configuration according to the present embodiment. The reliability determination unit 320 changes the level of the reliability based on the number of parts having a “high” possibility of failure in the list of part numbers output from the error determination unit 312.

In addition, in the present embodiment, the reliability determination unit 320 also uses, as an additional element, the number of field result records managed by the field result management unit 315 to determine the reliability. More specifically, in a case where the number of field repair results relating to a target error in a target model, which is used to calculate the failure cause probabilities, does not reach a reliable number (threshold), the reliability determination unit 320 reduces the reliability. In a case where the reliability is displayed with a plurality of levels, a plurality of thresholds may be prepared.

Table 9 illustrates an example of the reliability levels determined by the reliability determination unit 320.

TABLE 9

| | | Number of Field Results | |
|---|---|---|---|
| Estimation Accuracy | | Less than | Threshold or |
| Determination Matrix | | Threshold | More |
| Engine | With High Possibility | ** | *** |
| | Without High Possibility | * | ** |

The reliability level is determined based on whether output of an error determination device included in the error determination unit 312 includes information about a part having a high possibility of failure and whether the number of field results is the threshold or more. The number of icons, such as an asterisk “*”, used to indicate the reliability is increased as the number of pieces of usable information is increased. Information about the reliability determined by the reliability determination unit 320 is stored in the repair procedure display unit 319.

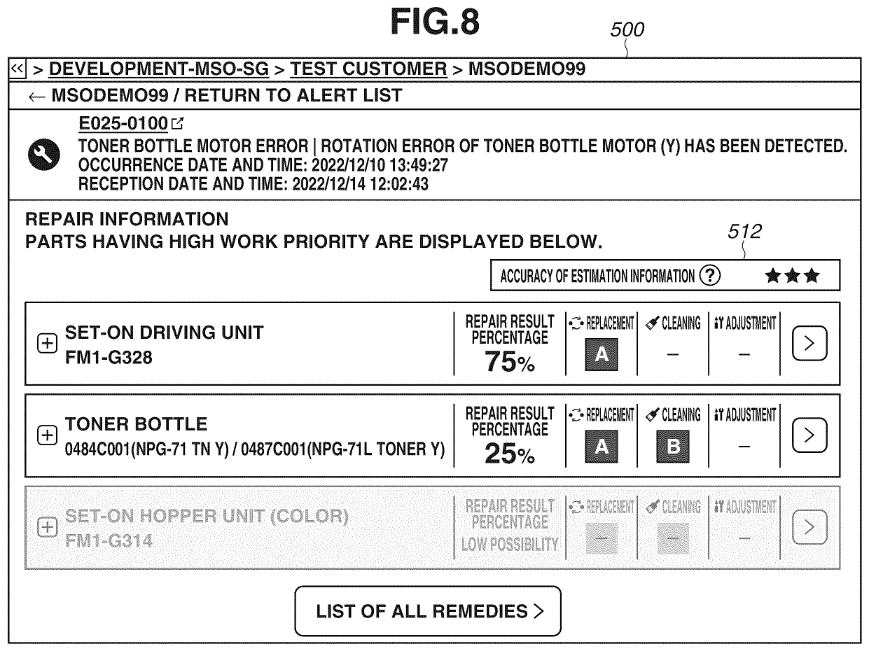

FIG. 8 illustrates an example of a screen that displays information about parts to be repaired, according to the present embodiment. As in FIG. 6 described above, the repair target part notification server 101 provides the repair procedure display screen 500 as a response to the repair procedure acquisition request, including the device ID and the error code, transmitted from the browser 331 of the PC 103. On the repair procedure display screen 500 in FIG. 8, a reliability display area 512 is displayed in addition to that in FIG. 6. In FIG. 8, three asterisks “***” are displayed to indicate that the reliability of the provided information is high because the failure possibility is determined to be “high” and the number of field results is determined to exceed the threshold.

The reliability may be determined based on one of the failure possibility and the number of field results.

The embodiments of the present disclosure also include an apparatus or a system, which is configured by appropriately combining the above-described embodiments, and a method thereof.

The embodiments of the present disclosure relate to an apparatus or a system, which executes at least one piece of software (program) for implementing the functions according to the above-described embodiments. A method for implementing the above-described embodiments that is executed by the apparatus or the system is also included in the embodiments of the present disclosure. The at least one program is supplied to the system or the apparatus via a network or various storage media, is loaded into at least one memory by at least one computer (e.g., a CPU or a microprocessor unit (MPU))) of the system or the apparatus, and is executed. In other words, the embodiments of the present disclosure further include the at least one program, and various computer-readable storage media storing the at least one program. Further, the embodiments of the present disclosure can be implemented by a circuit (e.g., an application specific integrated circuit (ASIC)) for implementing the functions according to the above-described embodiments.

According to the embodiments of the present disclosure, it is possible to provide information that enables execution of processes for eliminating an error occurring in an image processing apparatus, in appropriate order.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of priority from Japanese Patent Application No. 2023-007774, filed Jan. 23, 2023, which is hereby incorporated by reference herein in its entirety.

What is claimed is:

1. A system that provides information about a part for which a remedy is to be implemented to eliminate an error occurring in an image processing apparatus, the system comprising:
a management unit configured to manage, as field results, accumulated records of remedies that have been implemented for errors in image processing apparatuses in a past, wherein each of the field results includes information about an error, information about a model of an image processing apparatus in which the error has occurred, and information about a remedy for the error;
an identification unit configured to identify, based on a predetermined error occurring in an image processing apparatus, a plurality of parts each having a possibility of eliminating the predetermined error by being replaced;
a determination unit configured to determine a failure possibility of each of the identified plurality of parts based on the predetermined error and a history of errors that have occurred in the image processing apparatus in which the predetermined error occurs;
a calculation unit configured to calculate a failure cause probability of each of the identified plurality of parts based on information, in the field results, that matches the predetermined error and a model of the image processing apparatus in which the predetermined error occurs; and
a provision unit configured to provide, as information for eliminating the predetermined error, data for performing a display including information about the plurality of parts,
wherein, in the display, among the plurality of parts, for a part determined to be high in the failure possibility, information about the failure cause probability is provided, and for a part determined to be low in the failure possibility, information about not the failure cause probability but the failure possibility is provided.

2. The system according to claim 1, wherein the calculation unit calculates the failure cause probability based on the information matching the predetermined error and the model of the image processing apparatus in which the predetermined error occurs, among information, in the field results, that indicates replacement as the remedy.

3. The system according to claim 1, wherein, in the display, information about replacement, cleaning, and adjustment is also provided as recommended remedy information for each of the plurality of parts.

4. The system according to claim 1, further comprising a reliability determination unit configured to determine reliability of the provided information based on at least one of the failure possibility of each of the plurality of parts and a number of the field results used to calculate the failure cause probability,
wherein, in the display, information corresponding to the determined reliability is also provided.

5. A method for a system that provides information about a part for which a remedy is to be implemented to eliminate an error occurring in an image processing apparatus, the method comprising:
managing, as field results, accumulated records of remedies that have been implemented for errors in image processing apparatuses in a past, wherein each of the field results includes information about an error, information about a model of an image processing apparatus in which the error has occurred, and information about a remedy for the error;
identifying, based on a predetermined error occurring in an image processing apparatus, a plurality of parts each having a possibility of eliminating the predetermined error by being replaced;
determining a failure possibility of each of the identified plurality of parts based on the predetermined error and a history of errors that have occurred in the image processing apparatus in which the predetermined error occurs;
calculating a failure cause probability of each of the identified plurality of parts based on information, in the field results, that matches the predetermined error and a model of the image processing apparatus in which the predetermined error occurs; and
providing, as information for eliminating the predetermined error, data for performing a display including information about the plurality of parts,
wherein, in the display, among the plurality of parts, for a part determined to be high in the failure possibility, information about the failure cause probability is provided, and for a part determined to be low in the failure possibility, information about not the failure cause probability but the failure possibility is provided.
